(19) United States
(12) Patent Application Publication
(10) Pub. No.: US 2024/0150119 A1
(43) Pub. Date: May 9, 2024

(54) Lifting Device for Article Lifting

(71) Applicant: SANDEN RETAIL SYSTEMS CORPORATION, Isesaki-shi, Gunma (JP)

(72) Inventors: Masaru Tsunoda, Isesaki-shi, Gunma (JP); Mototaka TAJIKA, Isesaki-shi, Gunma (JP); Hideki KIMURA, Isesaki-shi, Gunma (JP)

(21) Appl. No.: 18/282,132

(22) PCT Filed: Mar. 4, 2022
(86) PCT No.: PCT/JP2022/009355

§ 371 Date: Sep. 14, 2023

(30) Foreign Application Priority Data
Mar. 26, 2021 (JP) 2021-052887

(51) Int. Cl. B65G 1/06

(52) U.S. Cl. CPC B65G 1/06

(57) ABSTRACT

A lifting device 8 with excellent transportability is provided. The lifting device 8 includes a first lifting unit 6 and a second lifting unit 7 disposed above the first lifting unit 6. The first lifting unit 6 includes a base 61, a first lifting platform 62 disposed above the base 61, and a first lifting system 63 which is provided between the base 61 and the first lifting platform 62 and which raises and lowers the first lifting platform 62. The second lifting unit 7 includes a second lifting platform 72 disposed above the first lifting platform 62, and a second lifting system 73 which raises and lowers the second lifting platform 72.

### TECHNICAL FIELD

The present invention relates to a lifting device provided in a storage space and the like for raising and lowering articles disposed on the lifting device.

### BACKGROUND ART

Patent Document 1 discloses a storage device (hereinafter, referred to as a “storage”). The storage includes two storage shelves spaced apart from each other with multiple storage sections for storing articles, an operating section for putting the articles in and taking the articles out provided on a part of one of the storage shelves, and an article conveying device (hereinafter referred to as “lifting device”) that raises and lowers the articles (specifically, a container on which an article is disposed) in a region between the two storage shelves. Furthermore, the lifting device in this storage also has a function of moving articles left to right, and front to rear, to convey the articles between the specified storage section and the operating section.

A lifting device disclosed in Patent Document 1 has a lifting platform provided between two storage shelves to be freely raised and lowered, and a wire-driven lifting system which raises and lowers the lifting platform. The lifting system has a lifting guide section which guides the lifting platform so as to move in a lifting direction (vertical direction). Furthermore, the lifting guide section has a height approximately equal to a height of the storage shelves, so that the lifting platform can be raised and lowered over substantially the entire height of the storage shelves.

### REFERENCE DOCUMENT LIST

### Patent Document

Patent Document 1: JP H08-85606 A

### SUMMARY OF THE INVENTION

### Problem to be Solved by the Invention

Preferably, a lifting device is pre-assembled as a finished product at a factory and the like, and then, the assembled lifting device is mounted at an installation site. However, since a dimension of a load on a vehicle for transporting the load from a factory to an installation site, is restricted, it is difficult to transport the assembled lifting device as a finished product to an installation site. Thus, it is necessary to improve transportability of the lifting device.

Thus, an object of the present application is to provide a lifting device having excellent transportability.

### Means for Solving the Problem

According to one aspect of the present invention, a lifting device for raising and lowering an article is provided. The lifting device comprises a first lifting unit, and a second lifting unit arranged above the first lifting unit. The first lifting unit includes a base, a first lifting platform disposed above the base, and a first lifting system which is provided between the base and the first lifting platform and which raises and lowers the first lifting platform. The second lifting unit includes a second lifting platform disposed above the first lifting platform, and a second lifting system which raises and lowers the second lifting platform.

### Effects of the Invention

The lifting device, according to one aspect of the present invention, comprises: the first lifting unit which includes the base, the first lifting platform disposed above the base, and a first lifting system which is provided between the base and the first lifting platform and which raises and lowers the first lifting platform, and the second lifting unit which includes the second lifting platform disposed above the first lifting platform, and the second lifting system which raises and lowers the second lifting platform. Thus, in the lifting device, the first lifting unit and the second lifting unit can be vertically separated from each other. These lifting units are classified as units which includes the lifting platforms (the first and second lifting platforms) and the lifting systems (the first and second lifting systems), respectively. Thus, each lifting unit has excellent assembly characteristics, so that each lifting unit is easily assembled at a factory and the like. In view of the above, in the lifting device, the first lifting unit and the second lifting unit can be vertically separated from each other, and thus, the first lifting unit and the second lifting unit are individually transported, so that it is possible to keep the low height of a package dimension during transportation. Accordingly, transportability of the lifting units is improved. As described above, it is possible to provide a lifting device which has excellent transportability.

### BRIEF DESCRIPTION OF THE DRAWINGS

FIG. 1 is a perspective view of a storage including a lifting device according to a first embodiment of the present invention.

FIG. 2 is a view illustrating an inner configuration of the storage.

FIG. 3 is a perspective view of a portable tray (tray) on which the article is disposed.

FIG. 4 is a side view of the tray.

FIG. 5 is a view illustrating a structure of a door system of the storage.

FIG. 6 is a front view of the lifting device.

FIG. 7 is a front view of a first lifting unit of the lifting device.

FIG. 8 is a side view of the first lifting unit.

FIGS. 9A-9D are partial cross-sectional views of the first lifting unit.

FIG. 10 is a front view of a second lifting unit of the lifting device.

FIG. 11 is a longitudinal sectional view of the second lifting unit.

FIG. 12 is a perspective view of a holder of the second lifting unit.

FIG. 13 is a perspective view illustrating an example of the state of using the holder.

FIG. 14 is a cross-sectional view of a vertical frame of the lifting unit.

FIG. 15 is a block diagram illustrating a schematic configuration of a control system of the storage.

FIG. 16 is a front view illustrating a lifting device according to a second embodiment of the present invention.

FIG. 17 is a front view illustrating a modification of the lifting device of the second embodiment.

FIG. 18 is a perspective view of the storage including the lifting device shown in FIG. 17.

### MODE FOR CARRYING OUT THE INVENTION

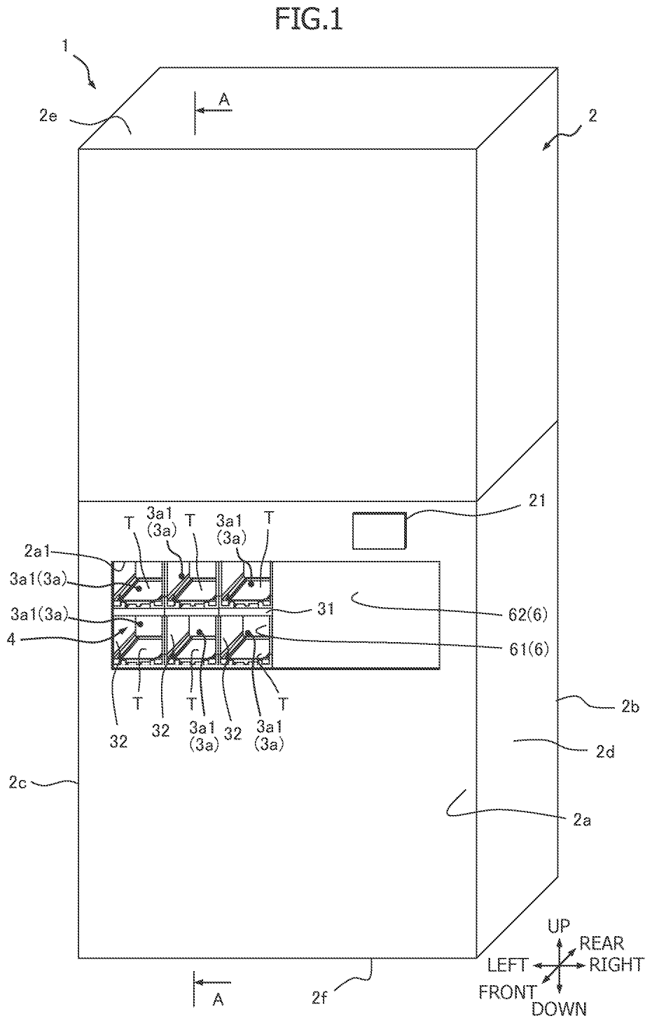

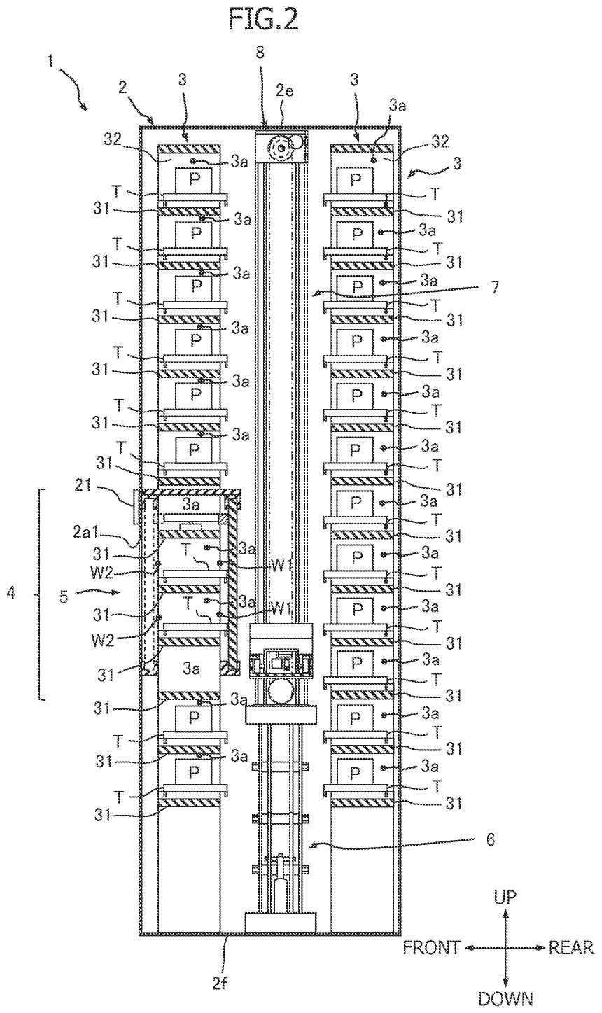

Hereinafter, embodiments of the present invention will be described with reference to the accompanying drawings. FIG. 1 is a perspective view of a storage 1 including a lifting device 8 for raising and lowering an article according to a first embodiment of the present invention. FIG. 2 is a conceptual diagram illustrating an inner configuration of the storage 1 for articles. FIG. 2 is a schematic longitudinal sectional view of the storage 1 taken along the line A-A of FIG. 1; however, a lower part of the lifting device 8 (a first lifting unit 6 described below) is shown as a side view in the figure for clarity.

The storage 1 is configured to accept and store multiple articles P, and to let stored multiple articles P taken out. As articles P to be stored, any articles such as medicines, electronic components, mechanical components, books, stationery items, tools, bottled beverages, and packaged foods, can be adopted. In the present embodiment, for example, the storage 1 may be placed in a pharmacy inside a building, and the storage 1 is adopted to control inventory of products (articles P) such as medicines to be sold. For example, a clerk may be a user of the storage 1, and the user performs operations such as putting articles P in the storage 1 and taking articles P out from the storage 1. However, the location and use of the storage 1 are not limited to the above. The storage 1 is appropriately placed according to any type of articles to be stored, and the storage 1 can be used for appropriate purposes (use embodiment) according to the location of the storage 1 and the type of articles.

In the present embodiment, it is assumed that a user accesses a storage 1 from the front side of the storage 1 in a front-rear direction. For illustration purposes, the front-rear, left-right, and up-down directions are shown in the drawings as appropriate, and the left-right direction is shown as viewed from the side at which the user stands in front of the storage 1

In the storage 1, for example, an article P is stored placed on a portable tray T. The stored P is conveyed on the tray T in the storage 1.

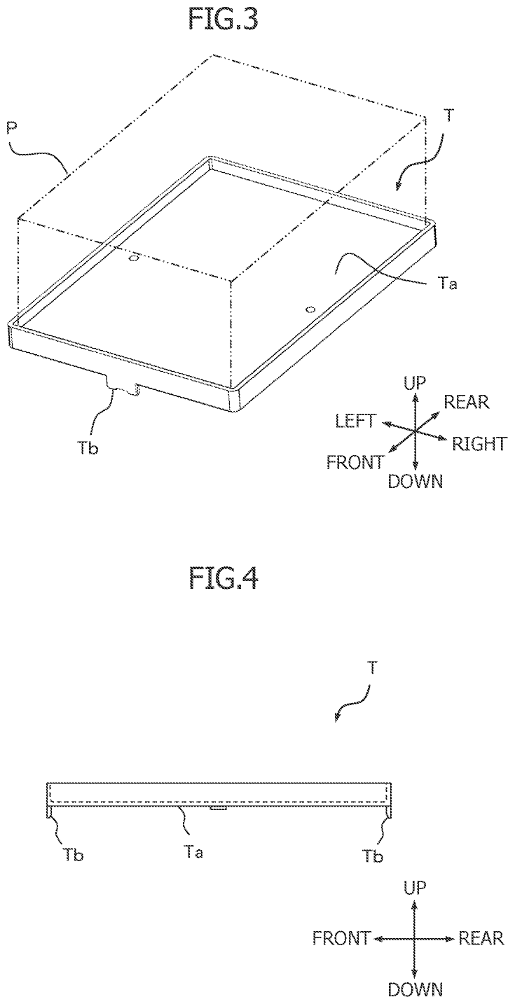

FIG. 3 is a perspective view of the tray T, and FIG. 4 is a side view of the tray T. In the present embodiment, the tray T has a plate-like main body Ta on which the article P is placed. The main body Ta is, for example, rectangular in a plane view. At both ends of a bottom surface of the main body Ta in the front-rear direction, protrusions Tb that protrude downward are formed.

The storage 1 includes a housing 2, storage shelves 3 for storing articles P, an operating station 4 provided in a part of the storage shelf 3, a door system 5 provided in the operating station 4, a lifting device 8 for raising and lowering the article P within the housing 2, the lifting device 8 including a first lifting unit 6 and a second lifting unit 7, and a control unit 9 for controlling entire operation and the like of the lifting device 8. In the present embodiment, the lifting device 8 has a function of raising and lowering the article P as well as moving the article P in left to right and front to rear, and is used as a device for conveying (transferring) the article P within the housing 2.

The housing 2 is formed in rectangular in shape and constitutes a case of the device. In the inside of the housing 2, each component constituting the device is arranged. The housing 2 has exterior panels including: a front panel 2a; a rear panel 2b; a left panel 2c, a right panel 2d; a top panel 2e; and a bottom panel 2f. For example, frame members (not shown) are provided at the inside of the exterior panels. The housing 2 includes the exterior panels and the frame members.

Storage shelves 3 are disposed along the lifting device 8, and articles P raised or lowered by the lifting device 8 is placed on the storage shelves 3. The storage shelves 3 are configured to store articles P placed on the trays T, and to be able to receive the multiple articles P (that is, multiple trays T on each of which the article P is placed). In the present embodiment, the storage shelves 3 are disposed in the respective areas of the front panel 2a side and the rear panel 2b side in the housing 2. The two storage shelves 3 are spaced apart and face each other, and the lifting device 8 is arranged in an area between the two storage shelves 3.

Each storage shelf 3 includes: multiple shelf boards 31 (12 steps in the drawing) arranged at intervals in the up-down direction and extending in the left-right direction; and multiple partition plates 32 arranged at intervals in the left-right direction in each shelf board 31 and each partition plate 32 extending in the up-down direction. Multiple article placement chambers 3a arranged in the up-down direction and the left-right direction, are formed by members (shelf board 31, partition plate 32, and the like) that constitutes the storage shelf 3, and the article P (tray T) can be disposed in each article placement chamber 3a. Each article placement chamber 3a is formed in a substantially rectangular tubular shape extending in the front-rear direction. The tray T is conveyed to the article placement chamber 3a so that, for example, one end including the protrusion Tb further protrudes toward the lifting device 8 than an end surface side of the storage shelf 3 on the lifting device 8. Although not particularly limited, each step of the storage shelf 3 is provided with six article placement chambers 3a.

The operating station 4 is used by a user to put the articles P in the storage 1 and take the articles P from the storage 1. In the present embodiment, the operating station 4 is configured by using a part of the storage shelf 3 on the front side (front panel 2a side, user side).

The operating station 4 is positioned, for example, at the third to sixth steps of the article placement chambers 3a from the front side bottom of the storage shelf 3. At the operating station 4, the fourth shelf board 31 from the bottom of the storage shelf 3 is positioned at a predetermined height (for example, about 1.3 m which is an average waist height of users from a floor), to facilitate operations performed by the user. At the operating station 4, article placement chambers 3a positioned at the fourth and fifth steps, that is, vertically arranged in two steps and horizontally arranged in six rows, are used for putting in and taking out the articles P. At a part of the front panel 2a which corresponds to the article placement chambers 3a positioned in the fourth and fifth steps, a panel opening 2a1 elongated and opened in a rectangular shape and in the left-right direction are provided. Each article placement chamber 3a at the fourth and fifth steps are accessible for both the user and the lifting device 8. However, as described below, a first opening W1 of the article placement chamber 3a at the lifting device 8 side and a second opening W2 of the article placement chamber 3a at the user side are opened and closed by a door system 5. Furthermore, at the front side of the storage shelf 3, the article placement chambers 3a at the third and sixth steps from the bottom are not used for placement of articles, but are instead used as spaces for constituting the operating station 4 and the door system 5.

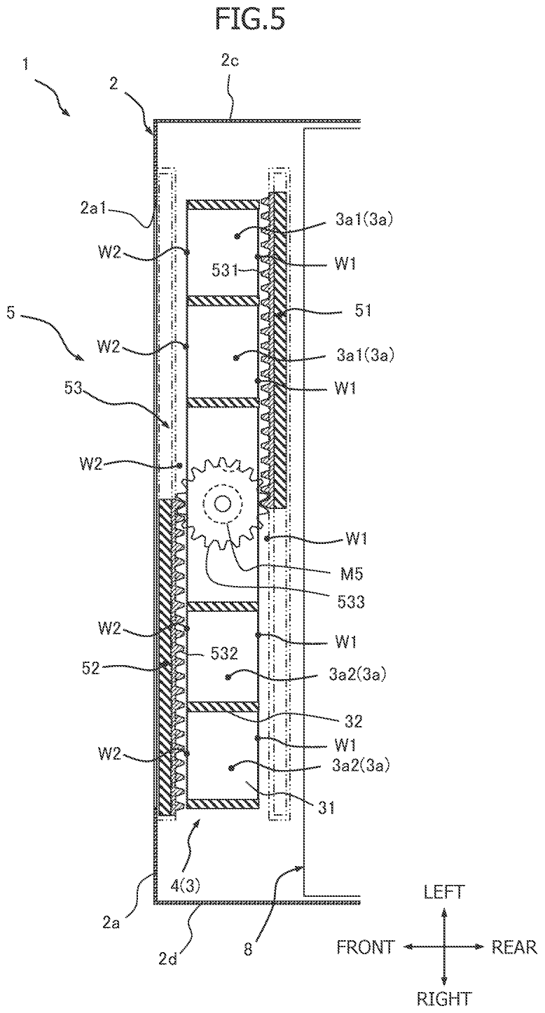

In the operating station 4, when it is necessary to distinguish between the left half side and the right half side of the article placement chambers 3a at the fourth and fifth stages from the bottom, the article placement chambers 3a on the left half side at the fourth and fifth steps are referred to as first article placement chambers 3a1 (see FIGS. 1 and 5 described below), and the article placement chambers 3a on the right half side at the fourth and fifth stages are referred to as second article placement chambers 3a2 (see FIG. 5).

The door system 5 opens and closes the first opening W1 of the first article placement chamber 3a1 and the second opening W2 of the second article placement chamber 3a2. The door system 5 is configured to switch between a first condition (see FIGS. 1 and 5) and a second condition, and in the first condition in which the first opening W1 of each first article placement chamber 3a1 is closed and the second opening W2 of each second article placement chamber 3a2 is closed, and in the second condition in which the first opening W1 of each second article placement chamber 3a2 is closed and the second opening W2 of each first article placement chamber 3a1 is closed. Thus, at the operating station 4, in the first condition, the lifting device 8 can access each second article placement chamber 3a2 at the right half side, and the user can access each first article placement chamber 3a1 at the left half side. In the second condition, the lifting device 8 can access each first article placement chamber 3a1 at the left half side, and the user can access each second article placement chamber 3a2 at the right half side.

FIG. 5 is a view illustrating a structure of the door system 5. In the present embodiment, the door system 5 includes a first door member 51 which opens and closes the first opening W1, a second door member 52 which opens and closes the second opening W2, and a door driving unit 53 which drives the first door member 51 and the second door member 52.

In the present embodiment, the first door member 51 and the second door member 52 are arranged apart from each other in the front-rear direction, and the first door member 51 and the second door member 52 are supported so as to be movable in the left-right direction. The first door member 51 is positioned between the front side storage shelf 3 and the lifting device 8, and the second door member 52 is positioned between the front panel 2a and the front side storage shelf 3. In the first condition of the door system 5, the first door member 51 closes the first opening W1 of each first article placement chamber 3a1, in the second condition of the door system 5, the first door member 51 closes the first opening W1 of each second article placement chamber 3a2. The door system 5 is configured such that, in each of the first and second conditions, the second door member 52 operates in an opposite manner to the first door member 51.

The door driving unit 53 is configured as a rack-and-pinion type driving unit which moves the first door member 51 and the second door member 52 in synchronization with each other, and for example, the door driving unit 53 is arranged at a space between the seventh shelf board 31 and the sixth shelf board 31. Specifically, the door driving unit 53 includes: a first rack gear section 531 attached to the first door member 51; a second rack gear section 532 attached to the second door member 52; a pinion gear section 533 having a gear that is disposed between the first rack gear section 531 and the second rack gear section 532 and that mashes with a gear of each of the first rack gear section 531 and the second rack gear section 532; a door driving motor M5 that rotates the pinion gear section 533; and a gear lock section (not shown) that prevents the pinion gear section 533 from rotating. In order to secure a space for arranging the pinion gear section 533 and the door driving motor M5, at the operating station 4, the partition plate 32 is not provided in the center portion in the left-right direction of the sixth shelf board 31. The door driving unit 53 rotates the pinion gear section 533 by the door driving motor M5 to move the first rack gear section 531 attached to the first door member 51 and the second rack gear section 532 attached to the second door member 52 in the left-right direction. That is, the first door member 51 and the second door member 52 move toward opposite sides with respect to each other in the left-right direction.

The lifting device 8 is a device for raising and lowering the article P placed on the device (that is, the tray T on which the article P is placed). In the present embodiment, the lifting device 8 is disposed between the two storage shelves 3 and is adopted as a device for conveying (transferring) the article P in the housing. Thus, the lifting device 8 has a function of moving the article P in the left-right direction and the front-rear direction, in addition to the function of raising and lowering the article P. The lifting device 8 moves the article P (tray T) between the article placement chamber 3a (3a1, 3a2) of the operating station 4 and the remaining article placement chambers 3a to convey the article P.

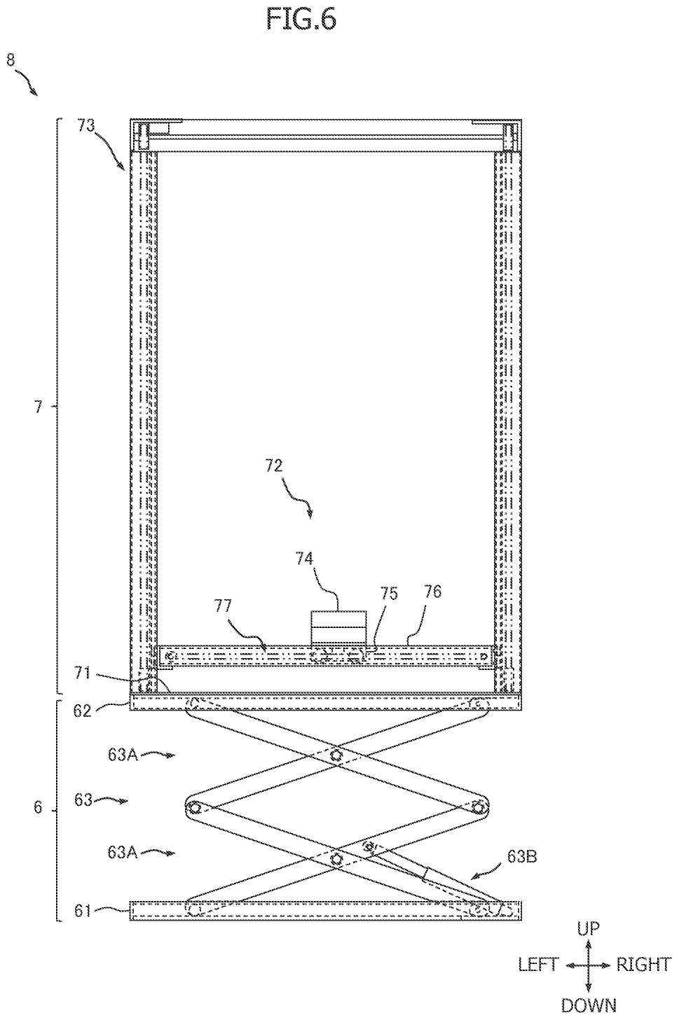

FIG. 6 is a front view of the lifting device 8. The lifting device 8 includes a first lifting unit 6 and a second lifting unit 7 which is disposed above the first lifting unit 6, and the first lifting unit and the second lifting unit can be vertically separated from each other. Furthermore, the housing 2 and each storage shelf 3 can be vertically separated according to the separation of the first lifting unit 6 and the second lifting unit 7 (see FIG. 1). Although the position at which the housing 2 and each storage shelf 3 are vertically separated is not particularly limited, the housing 2 and each storage shelf 3 are set to be vertically separated at the approximate middle height of each storage shelf 3 (for example, at a height corresponding to the upper surface of the seventh shelf board 31 of the storage shelf 3).

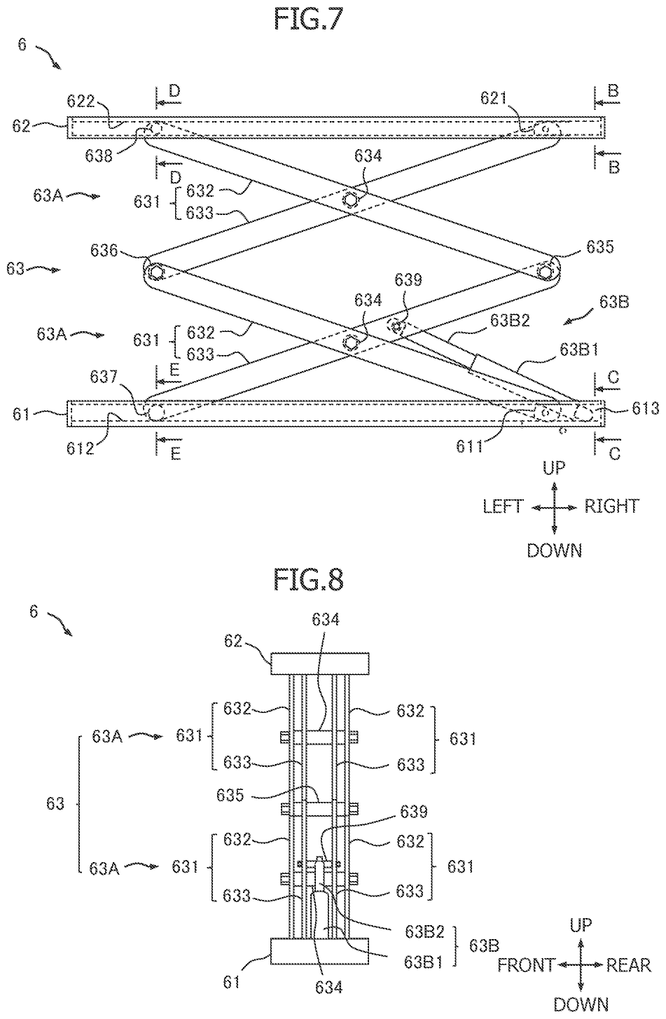

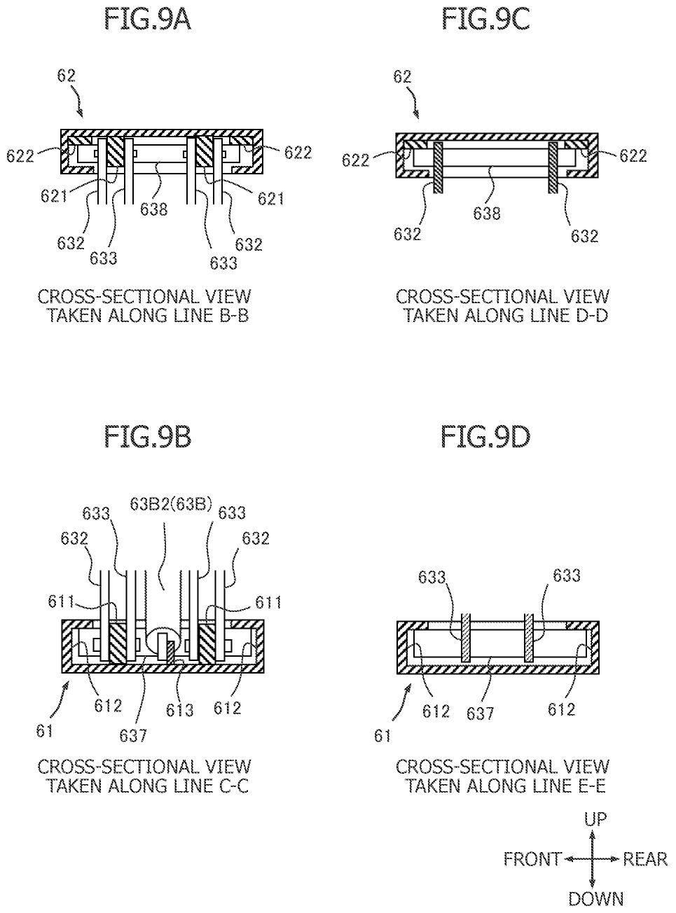

FIG. 7 is a front view of the first lifting unit 6, FIG. 8 is a right side view of the first lifting unit 6, and FIGS. 9A-9D are partial cross-sectional views of the first lifting unit 6 taken along the lines B-B, C-C, D-D, and E-E of FIG. 7, respectively.

The first lifting unit 6 includes a base 61, a first lifting platform 62, and a first lifting system 63. The second lifting unit 7 includes a base plate 71, a second lifting platform 72, and a second lifting system 73. That is, each lifting unit (6, 7) which can be vertically separated into an upper section and a lower section, includes a lifting platform (the first lifting platform 62, the second lifting platform 72, respectively) and a lifting system for raising and lowering the lifting platform (the first lifting system 63 and the second lifting system 73, respectively).

The base 61 forms the bottom of the entire lifting device 8. Here, the base 61 is formed in a rectangular shape elongated in the left-right direction of the storage shelf 3 in a plan view from above. The base 61 is disposed along the rear end of the front side storage shelf 3 and the front end of the rear side storage shelf 3 so that the long side of the base 61 extends in the left-right direction of the storage shelf 3, and has a length in the left-right direction (that is, a long side) which is equal to the length in the left-right direction of the storage shelf 3.

The first lifting platform 62 is disposed above the base 61 and forms the top of the first lifting unit 6. The first lifting platform 62 is formed in a rectangular shape having an external shape approximately the same as that of the base 61 in a plan view from above.

The first lifting system 63 is disposed between the base 61 and the first lifting platform 62, and the first lifting system 63 raises and lowers the first lifting platform 62. In the present embodiment, the first lifting system 63 is a pantograph type lifting system. The first lifting system 63 supports the first lifting platform 62 from below and raises and lowers the first lifting platform 62 while the first lifting platform 62 is maintained parallel to the base 61.

Specifically, the first lifting system 63 includes at least one pantograph arm unit 63A that constitutes an X-shaped link arm mechanism for connecting the base 61 and the first lifting platform 62, and an arm driving section 63B that drives the pantograph arm unit 63A.

In the present embodiment, the first lifting system 63 includes upper and lower pantograph arm units 63A which are vertically disposed, the lower end of the upper pantograph arm unit 63A is connected to the upper end of the lower pantograph arm unit 63A.

Each pantograph arm unit 63A includes, for example, two pantograph arms 631 spaced apart from each other at one long side and the other long side of the base 61. In other words, in this embodiment, two pantograph arms 631 of each pantograph arm units 63A are spaced apart in the front-rear direction in the storage 1. Furthermore, each of the pantograph arms 631 constitutes an X-shaped link member in which an outer arm 632 and an inner arm 633 are rotatably connected to each other in an X-shape. The pantograph arm unit 63A is disposed between the base 61 and the first lifting platform 62 so as to be vertically extended and retracted by changing a crossing angle between the outer arm 632 and the inner arm 633 of the pantograph arm unit 63A.

In each pantograph arm unit 63A, one pantograph arm 631 and the other pantograph arm 632 are connected by an intermediate connecting shaft 634. One end of the intermediate connecting shaft 634 is connected to the intersecting portion (approximately central portion in each longitudinal direction) of the outer arm 632 and the inner arm 633 of one pantograph arm 631. The other end of the intermediate connecting shaft 634 is connected to the intersecting portion of the outer arm 632 and the inner arm 633 of the other pantograph arm 631. The upper end of each outer arm 632 of the lower pantograph arm unit 63A is rotatably connected to the lower end of the corresponding inner arm 633 of the upper pantograph arm unit 63A. The upper end of each inner arm 633 of the lower pantograph arm unit 63A is rotatably connected to the lower end of the corresponding outer arm 632 of the upper pantograph arm unit 63A. Furthermore, the upper ends of the two inner arms 633 of the lower pantograph arm unit 63A are connected by a right-side connecting shaft 635, and the lower ends of the two inner arms 633 of the upper pantograph arm unit 63A are connected by a left-side connecting shaft 636.

In the lower pantograph arm unit 63A, the lower end of each outer arm 632 is rotatably supported by a lower support piece 611 provided to protrude from the inside of one short side (right side in the drawings) of the base 61. Furthermore, the lower ends of the two inner arms 633 of the lower pantograph arm unit 63A are connected by a lower slide shaft portion 637, and each end portion of the lower slide shaft portion 637 passes through the inner arm 633 and protrudes outward from the inner arm 633. On the inner wall of the long side portion of the base 61, a concaved lower guide groove 612 is formed over the entire long side portion, and the end portion of the lower slide shaft portion 637 is inserted into the lower guide groove 612 to movably guided in the extending direction of the long side of the base 61 (that is, the left-right direction of the storage shelf 3). Thus, the lower end of each inner arm 633 of the lower pantograph arm 63A is connected to the base 61 while the lower end of each inner arm 633 is movably guided by the lower slide shaft portion 637 and the lower guide groove 612 in the extending direction of the long side of the base 61.

In the upper pantograph arm unit 63A, the upper end of each inner arm 633 is rotatably supported by an upper support piece 621 provided to protrude from the inside of one short side (the right side of the drawing) of the first lifting platform 62. Furthermore, the upper ends of the two outer arms 632 of the upper pantograph arm unit 63A are connected by an upper slide shaft portion 638, and each end portion of the upper slide shaft portion 638 passes through the outer arm 632, which is connected by each end portion of the upper slide shaft portion 638, and protrudes outward from the outer arm 632. On the inner wall of the long side portion of the first lifting platform 62, a concaved upper guide groove 622 is formed over the entire long side portion, and the end of the upper slide shaft portion 638 is inserted into the upper guide groove 622 to movably guided in the extending direction of the long side of the first lifting platform 62 (that is, the left-right direction of the storage shelf 3). Thus, the upper end of each outer arm 632 of the upper pantograph arm 63A is connected to the first lifting platform 62, whereas the upper end of each outer arm 632 is movably guided by the upper slide shaft portion 638 and the upper guide groove 622 in the extending direction of the long side of the first lifting platform 62.

The arm driving section 63B moves (rotates) the outer arm 632 and the inner arm 633 to change the crossing angle between the outer and inner arms 632, 633 of the pantograph arm unit 63A, so that the pantograph arm unit 63A is vertically extended and retracted. The arm driving section 63B includes a fixed portion 63B1 that has an end portion rotatably connected to the base 61, and a movable portion 63B2 that has an end portion rotatably connected to a predetermined part of the pantograph arm unit 63A and that is movable relative to the fixed portion 63B1.

In the present embodiment, the arm driving section 63B is a hydraulically driven driving section, and includes a hydraulic cylinder that can be extended and retracted by hydraulic pressure. The fixed portion 63B1 is a cylinder section having an end portion that is rotatably connected to a fixed side support piece 613 that protrudes to be located between the two lower support piece 611 at one of the short sides of the base 61 (the right side of the drawing). That is, in the present embodiment, the fixed portion 63B1 is located between the lower ends of the two outer arms 632 of the lower pantograph arm unit 63A. The movable portion 63B2 is a rod section that is slidably guided within the fixed section 63B1 and moved relative to the fixed section 63B1 by hydraulic pressure. One end of the rod section is slidably supported within the fixed portion 63B1, and the other end of the rod section is rotatably connected to a drive connecting shaft 639 provided between the two inner arms 633 of the lower pantograph arm unit 63A. For example, the drive connecting shaft 639 is located between the intermediate connecting shaft 634 and the right-side connecting shaft 635 of the lower pantograph arm unit 63A and closer to the side of the intermediate connecting shaft 634, and the drive connecting shaft 639 extends parallel to the intermediate connecting shaft 634 and the right-side connecting shaft 635 to connect the two inner arms 633.

In the first lifting unit 6, when the arm driving section 63B is driven in the extending direction, the crossing angle between the outer arm 632 and the inner arm 633 changes to extend each pantograph arm unit 63A in the vertical direction. When the arm driving section 63B is driven in the retracting direction, the crossing angle changes to retract each pantograph arm unit 63A in the vertical direction. During the extending and retracting of the pantograph arm unit 63A, the first lifting platform 62 is raised and lowered in the vertical direction by the pantograph arm unit 63A while the first lifting platform 62 is maintained parallel to the base 61.

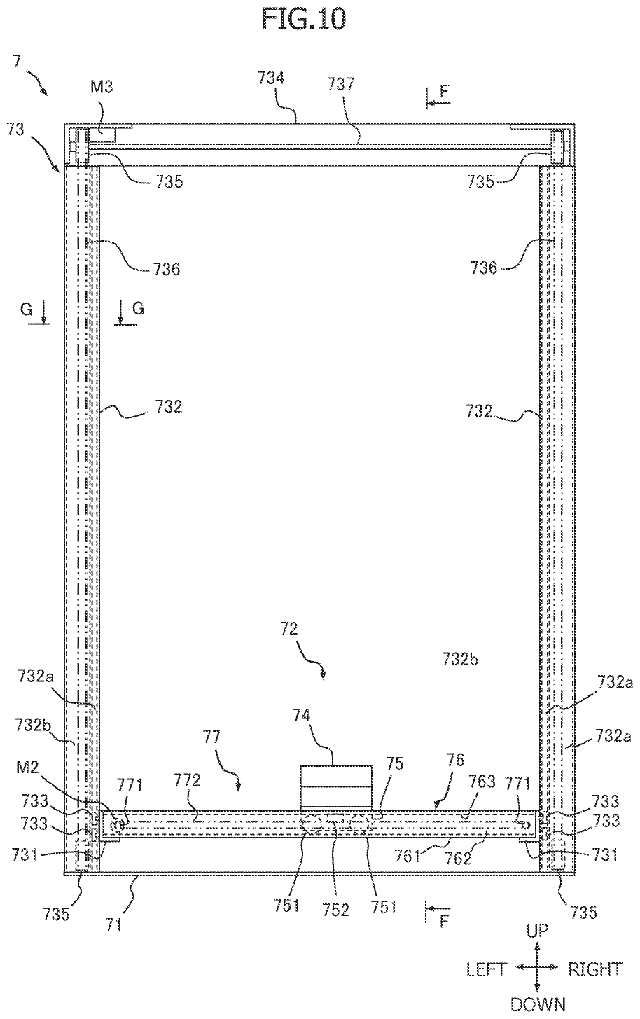

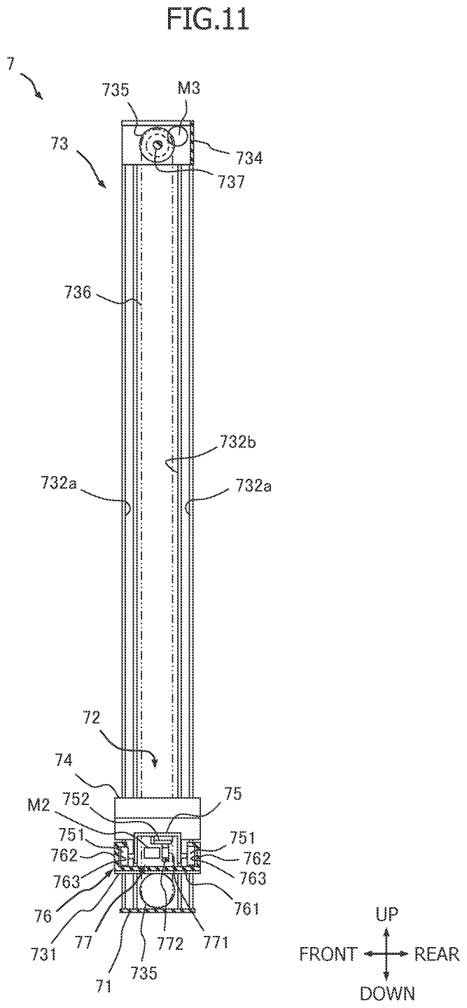

FIG. 10 is a front view of a second lifting unit 7 and FIG. 11 is a longitudinal sectional view of the second lifting unit 7 taken along the line F-F of FIG. 10. As described above, the second lifting unit 7 includes the base plate 71, the second lifting platform 72 disposed above the first lifting platform 62, and the second lifting system 73 for raising and lowering the second lifting platform 72. In the present embodiment, the second lifting unit 7 is mounted on the first lifting platform 62 of the first lifting unit 6 (see FIG. 6). Thus, the entire second lifting unit 7 is raised and lowered in the vertical direction by the first lifting unit 6.

The base plate 71 is the bottom of the second lifting unit 7. Here, the base plate 71 is formed in the same shape as the base 61 and the first lifting platform 62 of the first lifting unit 6 in a plan view from above, and is fixed on the top surface of the first lifting platform 62.

The second lifting platform 72 is disposed above the base plate 71 on which the article P (in detail, the tray T on which the article P is placed) is placed and supported to be raised and lowered in the vertical direction. In the present embodiment, the second lifting platform 72 has a function of moving the abovementioned article P in the lifting device 8 in the left-right direction and the front-rear direction.

The second lifting platform 72 includes a holder 74 having a function of moving the article P in the front-rear direction, a securing plate 75, a second lifting platform body 76, and a lateral movement system 77.

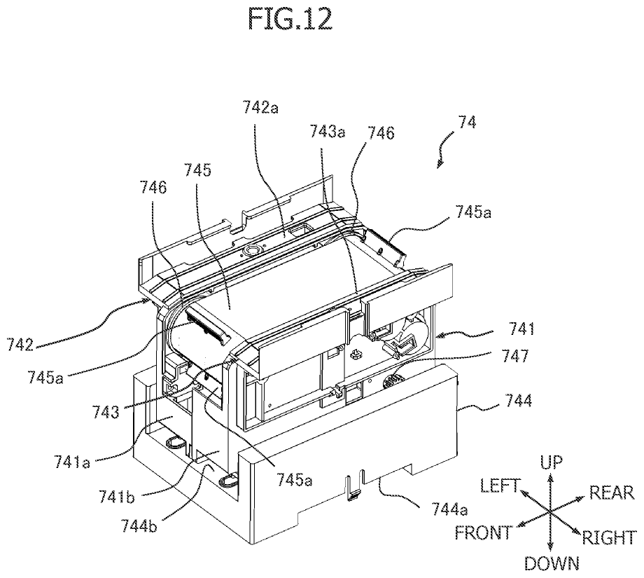

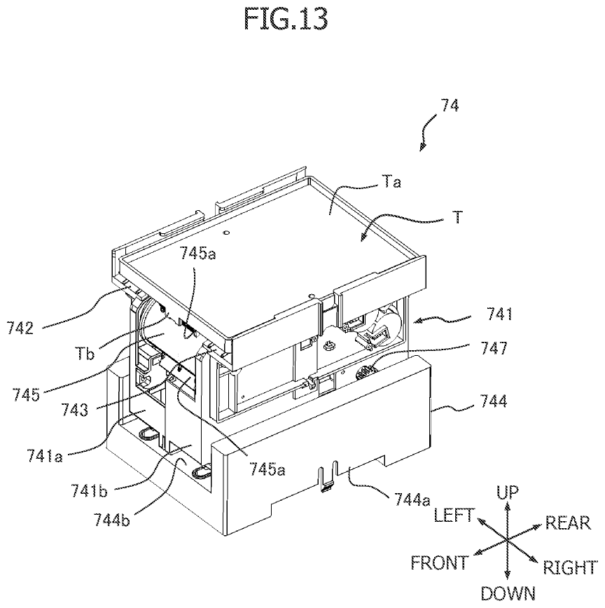

FIG. 12 is a perspective view of a holder 74, and FIG. 13 is a perspective view illustrating an example of the state of using the holder 74. The holder 74 has a function of placing the article P (tray T) and moving the placed article P (tray T) in the front-rear direction. The holder 74 includes a holder body 741, a left holding section 742 provided at the left end of the upper portion of the holder body 741, a right holding section 743 provided at the right end of the upper portion of the holder body 741, a body supporting section 744 that supports the holder body 741 from the bottom.

The holder body 741 includes a left housing 741a and a right housing 741b. An endless belt 745 is provided between the top of the left housing 741a and the top of the right housing 741b. Between the left housing 741a and the right housing 741b, the endless belt 745 is extended over a pair of front and rear drums 746, 746 extending in the left-right direction. Inside the holder body 741, a belt drive motor M (see FIG. 15) for rotationally driving the one drum 746 is provided. The endless belt 745 is provided with multiple protruding portions 745a.

The left holding section 742 and the right holding section 743 are provided to protrude outward from the upper end portion of the holder body 741, and the each holding section has surface on which the bottom surface of the tray T abuts. With the tray T placed on the left holding section 742 and the right holding section 743, an upper running section of the endless belt 745 runs forward or rearward in response to the rotational direction of one drum 746. In response to this running, when the protruding portions 745a move forward or rearward, any one of the protruding portions 745a abuts a front projection Tb or a rear projection Tb of the tray T. Accordingly, the tray T moves forward or rearward on the holder 74.

The lower portion of the body supporting section 744 has a mating groove 744a extending in the left-right direction (an extending direction of the long side of the second lifting platform 72) into which the securing plate 75 is mated. The upper portion of the body supporting section 744 has a holder guide groove 744b extending in the front-rear direction (an extending direction of the short side of the second lifting platform 72). The holder body 741 is guided by the holder guide groove 744b to be movable in the front-rear direction. The holder 74 is provided with a front-rear drive mechanism for moving the holder body 741 in the front-rear direction. Specifically, the front-rear drive mechanism includes a Z drive motor M4 (see FIG. 15) provided in the holder body 741, a pinion gear section 747 rotationally driven by the Z drive motor M4, and a rack gear section extending in the front-rear direction on the inner wall of the holder guide groove 744b of the body supporting section 744, the rack gear section having a gear meshing with the pinion gear section 747 is provided.

The holder body 741 moves forward or rearward as the pinion gear portion 747 is rotated by the Z drive motor M4. When the upper running section of the endless belt 745 is run by the belt drive motor M1, the protruding portion 745a of the endless belt 745 abuts the back surface of the projection Tb of the tray T placed in the article placement chamber 3a of the storage shelf 3, so that the tray T is pulled close to the holder body 741 side. The tray T pulled close to the holder body 741 side is placed on the left holding section 742 and the right holding section 743, and then, the article P is conveyed from the article placement chamber 3a to the holder 74. Furthermore, when the article P is conveyed from the holder 74 to the article placement chamber 3a, the tray T is conveyed to the article placement chamber 3a by driving the belt drive motor M1 while the holder body 741 is brought closer to the storage shelf 3 by driving the Z drive motor M4.

In FIGS. 10 and 11, the securing plate 75 is a plate to which the holder 74 is fixed. The securing plate 75 is a member having a U-shaped cross section with downward opening and extending in the left-right direction, and the holder body 741 is secured at the upper portion of the securing plate 75. At a portion of the securing plate 75 that further protrudes downward than the bottom of the holder 74, two first rollers 751 are spaced apart from each other in the left-right direction at both the front surface of the front side securing plate 75 and the rear surface of the rear side securing plate 75, to be rotatably mounted around a central axis extending in the front-back direction.

The second lifting platform body 76 is a member that forms the main structure of the second lifting platform 72 and that extends in the left-right direction parallel to the fixed plate 75. In the present embodiment, the second lifting platform body 76 includes a bottom wall portion 761 facing the securing plate 75, side wall portions 762 provided at the front and rear ends of the bottom wall portion 761. An inner wall of each side wall portion 762 is formed with a lateral guide groove 763 in which two first rollers 751 attached to the securing plate 75 are guided so as to be movable in the left-right direction.

The lateral movement system 77 is a system for moving the holder 74 in the left-right direction. The lateral movement system 77 is disposed, for example, in the second lifting platform body 76, and includes a pair of left and right pulleys 771, 771 and an X drive belt 772 extended over the pair of left and right pulleys 771, 771, and an X drive motor M2 for rotationally driving one of the pair of left and right pulleys 771, 771. At a predetermined position in the circumferential direction of the X drive belt 772, a belt securing piece 752 protruding from the securing plate 75, is secured. In the lateral movement system 77, when the X drive motor M2 is driven, the securing plate 75 secured to the X drive belt 772 moves in the left-right direction along the lateral guide groove 763 of the second lifting platform body 76, so that the holder 74 on the securing plate 75, in other words, the article P (tray T) moves in the left-right direction.

The second lifting system 73 is a system for raising and lowering the second lifting platform 72. In the present embodiment, the second lifting system 73 includes a support plate 731 that supports the second lifting platform 72, and a pair of vertical frames 732, 732 faced each other and spaced apart in a direction orthogonal to the lifting direction of the second lifting platform 72 (the left-right direction in the drawing). In the second lifting system 73, the second lifting platform 72 is raised and lowered between and along the pair of vertical frames 732, 732.

The support plates 731 are attached to the left and right ends of the second lifting platform 72 (in detail, the second lifting platform body 76). The left and right support plates 731 support the second lifting platform 72 (the second lifting platform body 76) so as to be parallel to the base plate 71. The support plates 731 is formed, for example, in an L-shape and is mounted to cover the left and right ends of the second lifting platform body 76. Four second rollers 733 spaced apart from each other in the front-rear and left-right directions, are rotatably mounted on each support plate 731 around a central axis protruding outward in the left-right direction.

Each vertical frame 732 extends perpendicularly to the upper surface of the base plate 71, and the lower end of each vertical frame 732 is secured to the left-right ends of the upper surface of the base plate 71.

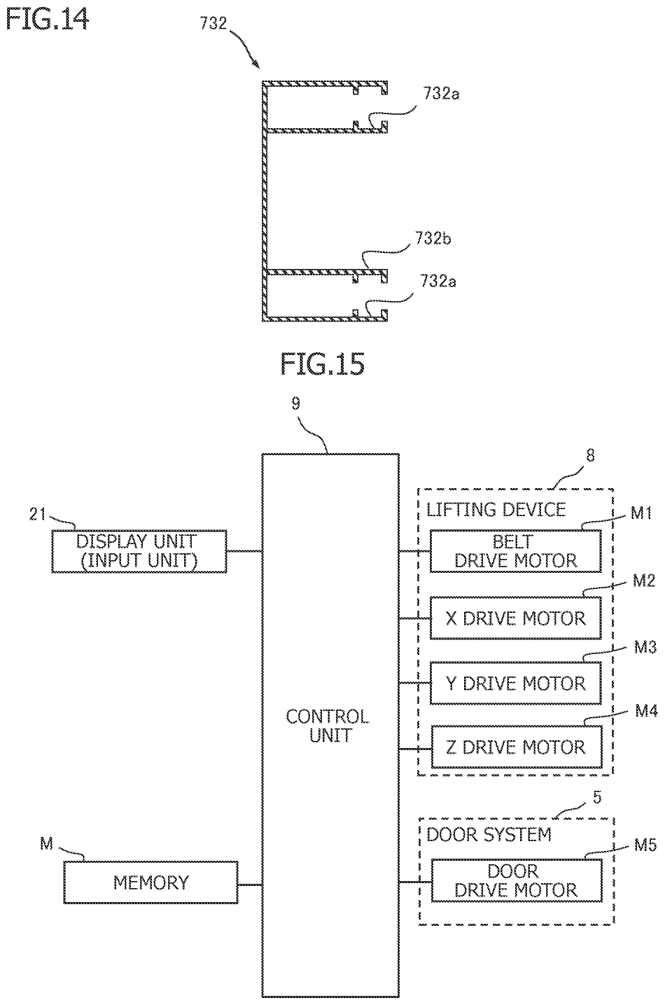

FIG. 14 is a cross-sectional view of the vertical frame 732 taken along the line G-G of FIG. 10. On each of the right side portion of the left vertical frame 732 and on the left side portion of the right vertical frame 732, two longitudinal guide grooves 732a are apart from each other in the front-rear direction and extending in the vertical direction, and a belt accommodating groove 732b extending in the vertical direction between the two longitudinal guide grooves 732a, are formed over the entire longitudinal direction (vertical direction) of the vertical frame 732.

Furthermore, the upper portions of the left vertical frame 732 and the right vertical frame 732 are connected by a reinforcing frame 734 (see FIGS. 10 and 11). The second lifting unit 7 may not have the base plate 71. In this case, the lower ends of the vertical frames 732, 732 are secured to the end portions in the left-right direction of the upper surface of the first lifting platform 62.

In the belt accommodating groove 732b of each vertical frame 732, a pair of upper and lower pulleys 735, 735 is rotatably provided around a central axis extending in the left-right direction. A Y drive belt 736 is extended over the pulleys 735, 735. The left support plate 731 is secured at a first predetermined position in the circumferential direction of the Y drive belt 736 provided on the left vertical frame 732, and the right support plate 731 is secured at a second predetermined position in the circumferential direction of the Y drive belt 736 provided on the right vertical frame 732. The upper pulley 735 provided on the left vertical frame 732 and the upper pulley 735 provided on the right vertical frame 732 are connected to each other via a drive transmission shaft 737. Furthermore, to the upper portion of the left vertical frame 732, a Y drive motor M3, which drives and rotates the upper pulley 735, is attached.

In other words, the second lifting system 73 is a belt-driven lifting system. Specifically, the second lifting system 73 includes the support plate 731, the pair of vertical frames 732, 732, the four second rollers 733, the reinforcing frame 734, the two pairs of the upper and lower pulleys 735, 735, the Y drive belt 736, the drive transmission shaft 737, and the Y drive motor M3.

The second lifting unit 7 drives the upper pulley 735 provided on the left vertical frame 732 and the upper pulley 735 provided on the right vertical frame 732 to rotate by the Y drive motor M3, so that the second lifting platform 72 including the holder 74 is moved (raised and lowered) in the vertical direction in the housing 2, and the second lifting unit 7 moves the holder 74 in the left-right direction in the housing 2 by driving one of the pair of left and right pulleys 771, 771 to rotate by the X drive motor M2. The second lifting unit 7 described here is merely an example, and various types of moving systems that can move the holder 74 vertically and horizontally can be used.

Here, as shown in FIGS. 1 and 2, the front panel 2a of the housing 2 is provided with a touchscreen display 21 having a function of displaying various information, as an input screen. The touchscreen display 21 can display information about each article P stored in the storage 1 (article name, type and the like) and provide an input screen for inputting various commands. For example, when the touch-screen display 21 displays the article name of each article P stored on the storage shelf 3, the user touches a displayed portion of the article name to input a conveying article selection command for selecting the article P to be conveyed from the storage shelf 3 to the operating station 4 by the lifting device 8. The control unit 9 controls the display operation of the display 21. Furthermore, the command and the like input by the touch operation to the display 21, is output to the control unit 9.

FIG. 15 is a block diagram illustrating a schematic configuration of a control system of the storage 1. As shown in FIG. 15, the storage 1 includes a memory M and the control unit 9.

The memory M stores, for example, various programs and data. In the present embodiment, the memory M stores information (for example, the information on the article to be conveyed) related to each article placement chamber 3a and the article P placed on the article placement chamber 3a.

The control unit 9 includes CPU, I/O, ROM, RAM, and the like, and comprehensively controls the operation of the door system 5 and the lifting device 8 in the storage 1. Specifically, the control unit 9 performs: (1) a process for conveying the stored article P from the storage 1 to the operating station 4 (article conveying-out process); (2) a process for switching between an access area for users and an access area for the conveying system in the operating station 4 (access area switching process); and (3) a process for conveying a new article P into the storage shelf 3 (article conveying-in process), and in each process, the control unit 9 controls the door system 5 and the lifting device 8.

Next, for example, raising and lowering operation and raising and lowering stroke of the lifting device 8 in the storage 1 will be described in view of FIG. 2.

In the lifting device 8, the first lifting unit 6 drives the arm driving section 63B in response to the command output from the control unit 9 to raise and lower the first lifting platform 62 between a first lower position and a first upper position. At that time, the entire second lifting unit 7 vertically raises and lowers in response to the raising and lowering of the first lifting unit 6. Furthermore, the second lifting unit 7 drives the Y drive motor M3 in response to the command output from the control unit 9 to raise and lower the second lifting platform 72 between a second lower position and a second upper position. Accordingly, the lifting device 8 vertically raises and lowers the article P by the total stroke obtained by adding the lifting stroke of the first lifting unit 6 and the lifting stroke of the second lifting unit 7.

The first lower position and the first upper position, are the height positions, for example, from the bottom surface of the base 61 to the top surface of the first lifting platform 62, and the difference between the first lower position and the first upper position is the lifting stroke of the first lifting unit 6. The second lower position and the second upper position, are the height positions, for example, from the bottom surface of the base plate 71 (that is, the top surface of the first lifting platform 62) to the top surface of the second lifting platform 72, and the difference between the second lower position and the second upper position is the lifting stroke of the second lifting unit 7.

Here, for example, in a state in which the first lifting platform 62 is located at the first lower position and the second lifting platform 72 is located at the second lower position, the height of the lowest shelf board 31 (first step) is set so that the article P can be conveyed between the holder 74 and the lowest (first step) article placement chamber 3a. Furthermore, in a state in which the first lifting platform 62 is located at the first upper position and the second lifting platform 72 is located at the second lower position, the height of the shelf board 31 (that is, fourth step from the bottom) that constitutes the lower article placement chamber 3a in the operating station 4 is set so that the article P can be conveyed between the holder 74 and the lower article placement chamber 3a in the operating station 4 (that is, fourth step article placement chamber 3a of the storage shelf 3). Furthermore, in a state in which the first lifting platform 62 is located at the first upper position and the second lifting platform 72 is located at the second upper position, the height of the uppermost shelf board 31 is set so that the article P can be conveyed between the holder 74 and the uppermost article placement chamber 3a (twelfth step). In addition, in the present embodiment, the entire height of the lifting device 8 changes according to the lifting operation of the first lifting platform 62, and the entire height is maximum when the first lifting platform 62 is located at the first upper position. At that time, the entire height of the second lifting unit 7 is set so that the top surface of the second lifting unit 7 does not collide with the top panel 2e of the housing 2.

The lifting device 8 is configured such that, in the standby state, for example, the first lifting platform 62 is located at the first upper position and the second lifting platform 72 is located at the second lower position. When the lifting device 8 raises and lowers the holder 74 in a lifting range which corresponds to a range from the first step article placement chamber 3a to the fourth step article placement chamber 3a (in the operating station 4, the article placement chambers 3a at the lower side), for example, only the first lifting platform 62 is raised and lowered, and when the lifting device 8 raises and lowers the holder 74 in the lifting range which corresponds to a range from the fourth step article placement chamber 3a to the twelfth step article placement chamber 3a, only the second lifting platform 72 is raised and lowered.

The lifting device 8 according to the present embodiment has the first lifting unit 6 and the second lifting unit 7 disposed above the first lifting unit 6. Thus, in the lifting device 8, the first lifting unit 6 and the second lifting unit 7 can be vertically separated from each other. The lifting units 6 and 7 are classified to include the lifting platforms (the first lifting platform 62 and the second lifting platform 72, respectively) and the lifting systems (the first lifting system 63 and the second lifting system 73, respectively), and thus, the lifting units 6 and 7 have excellent individual assembly characteristics, and can be easily assembled separately at a factory and the like. Accordingly, in the lifting device 8, the first lifting unit 6 and the second lifting unit 7 can be vertically separated from each other and are individually transported. As a result, the height of the lifting units during transportation can be reduced to easily improve transportability. In view of the above, it is possible to provide the lifting device 8 with excellent transportability.

In the present embodiment, the first lifting system 63 of the first lifting unit 6 is a pantograph type lifting system. Thus, the first lifting unit 6 has a configuration in which the first lifting platform 62 can be stably supported from the bottom, and relatively high loads can be withstood, and furthermore, the first lifting unit 6 easily generates high lifting force. Furthermore, the first lifting unit 6 can be transported in a state in which the first lifting unit 6 is retracted to the minimum height (that is, the first lifting platform 62 is disposed at the first lower position), so that the transportability is further improved.

In the present embodiment, the second lifting system 73 of the second lifting unit 7 is a lifting system that raises and lowers the second lifting platform 72 between and along the pair of vertical frames 732, 732. That is, most of the components of the second lifting system 73 are arranged on the left and right sides of the second lifting platform 72, and a space for raising and lowering the second lifting platform 72 is easily secured between the two storage shelves 3.

In the present embodiment, the second lifting unit 7 is mounted on the first lifting platform 62 of the first lifting unit 6. Thus, at the installation site, assembly of the lifting unit 8 is completed simply by mounting the second lifting unit 7 on top of the first lifting unit 6, and it is possible to provide the lifting unit 8 with excellent ease of assembly. Furthermore, when the first lifting platform 62 is raised and lowered, the second lifting platform 72 is also raised and lowered. Thus, in a lifting range that cannot be reached by only raising and lowering the second lifting unit 7, the lifting platform 62 is further raised and lowered to reach the lifting range. In a state in which the first lifting platform 62 is located at the first lower position (that is, the first lifting unit 6 is retracted to the minimum height), when the total height of the lifting device 8 is lower than an upper limit of a package size of a load of a vehicle for transportation, the lifting device 8 can be assembled as finished product in a factory and the like, to be transported directly from the factory to the installation site.

Furthermore, the first lifting system 63, which is a pantograph type lifting mechanism, has relatively high rigidity and can easily generate the high lifting force, so that the entire second lifting unit 7 can be easily raised and lowered. The second lifting system 73 is a belt-driven lifting system, and thus, the second lifting system 73 is suitable for raising and lowering relatively low-loaded articles P.

For example, when the lifting device is simply formed by the two upper and lower second lifting units 7 vertically arranged, an area (dead space) in which the article P (tray T) cannot be raised and lowered is generated between the second lifting platform 72 at the second upper position of the lower second lifting unit 7 and the second lifting platform 72 at the second lower position of the upper lifting unit 7. That is, in the lifting device, there is a dead space generated between the lifting units vertically arranged. In the lifting device 8 according to the present embodiment, since the entire second lifting unit 7 can be lifted by the first lifting unit 6, the dead space described above is not generated, and the region of the intermediate portion of the lifting device 8 in the vertical direction can be effectively utilized.

Next, the lifting device 8 according to a second embodiment of the present invention will be described. Hereinafter, components similar to those in the first embodiment will be denoted by the same reference numerals, and description thereof will be omitted, and differences from the first embodiment will be mainly described.

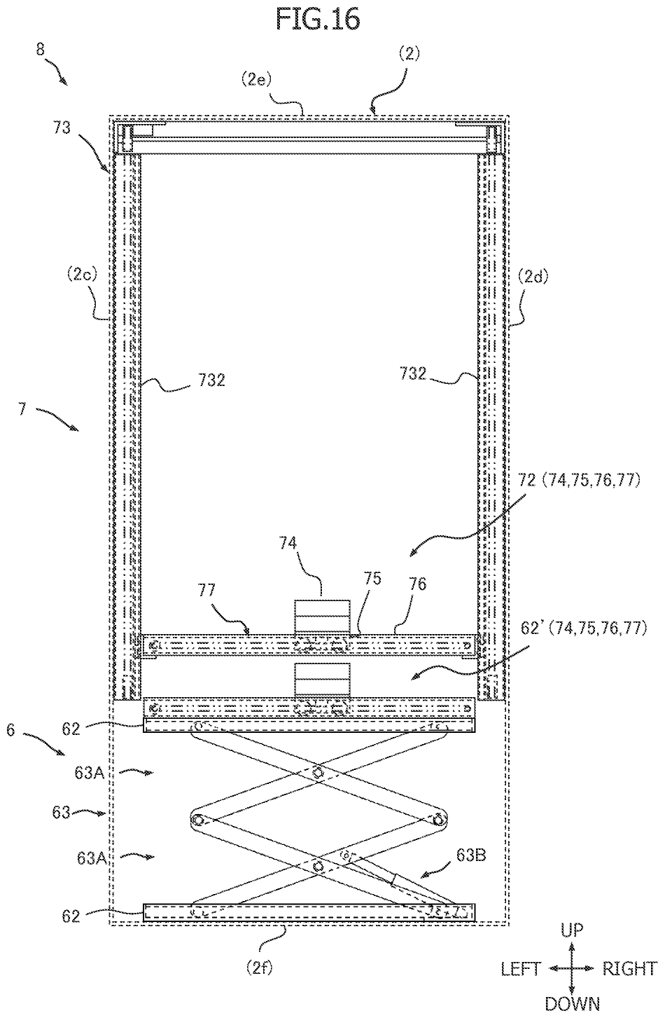

FIG. 16 is a front view illustrating the lifting device 8 according to the second embodiment of the present invention. In the lifting device 8 according to the second embodiment of the present invention, the second lifting unit 7 is attached to the housing 2, and the entire second lifting unit 7 is not raised and lowered. Specifically, the left vertical frame 732 of the second lifting unit 7 is secured to the left panel 2c of the outer panel of the housing 2 or a portion of the frame member of the housing 2 at the left panel 2c side, and the right vertical frame 732 of the second lifting unit 7 is secured to the right panel 2d of the outer panel of the housing 2 or a portion of the frame member of the housing 2 at the left panel 2c side. In the second embodiment, the second lifting unit 7 do not have a base plate 71.

In the second embodiment, in a plan view of the second lifting unit 7 viewed from above, the first lifting unit 6 is arranged within the inner region of the pair of vertical frames 732, 732. Thus, the upper limit position (that is, the first upper position) of the lifting range of the first lifting platform 62 can be raised to a range surrounded by the bottom surface of the second lifting platform 72 at the second lower position and parts of the vertical frames 732 below the bottom surface of the second lifting platform 72, so that the range between the first lifting unit 6 and the second lifting unit 7 can be effectively utilized.

In the second embodiment, in the maximally extended state (that is, the first lifting platform 62 is located at the first upper position), the pantograph-type first lifting system 63 of the first lifting unit 6 has the lifting stroke which can reach at least the lower limit region of the second lifting platform 72 of the second lifting system 73. Thus, even if the entire second lifting unit 7 is not raised and lowered, there is no region (dead space) in which the article P (tray T) cannot be raised and lowered, is generated between the first lifting platform 62 and the second lifting platform 72, so that the region of the intermediate portion of the lifting device 8 in the vertical direction can be effectively utilized.

Specifically, in the second embodiment, the first lifting unit 6 includes, for example, the second lifting platform 72 of the second lifting unit 7 (the holder 74, the securing plate 75, the second lifting platform body 76 and the lateral movement mechanism 77) and a platform 62′ with the same configuration, and the platform 62′ is mounted on the first lifting platform 62. Thus, the first lifting unit 6 and the second lifting unit 7 can individually convey the article P, so that the transfer efficiency is improved. Furthermore, since the first lifting system 63 can generate lifting force greater than that of the second lifting system 73, for example, the first lifting unit 6 can be applied to convey relatively heavy articles P, while the second lifting unit 7 can be applied to convey relatively light articles P.

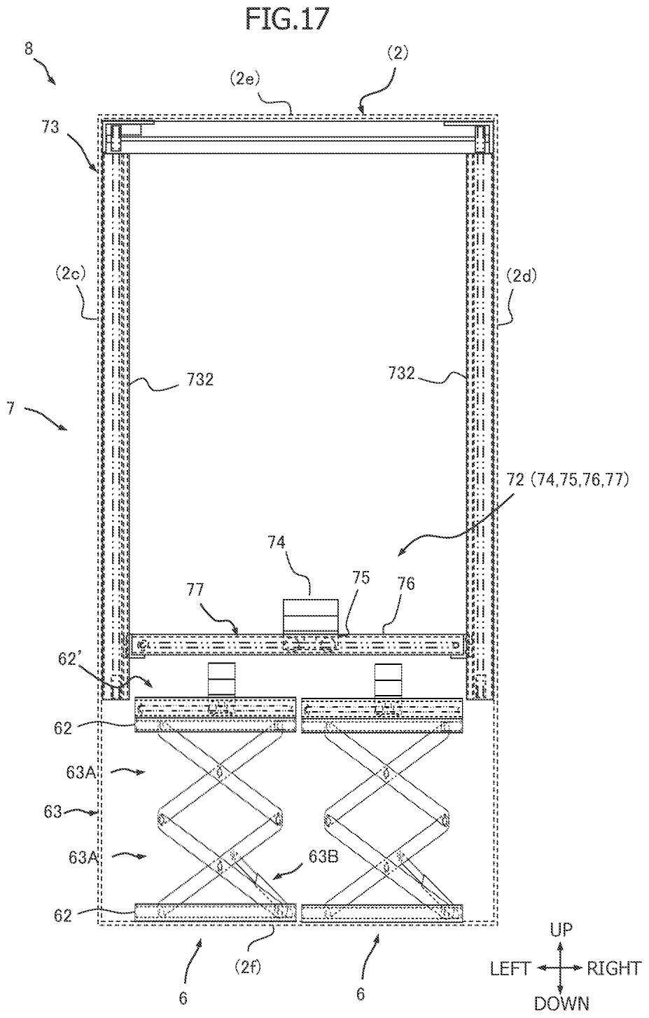

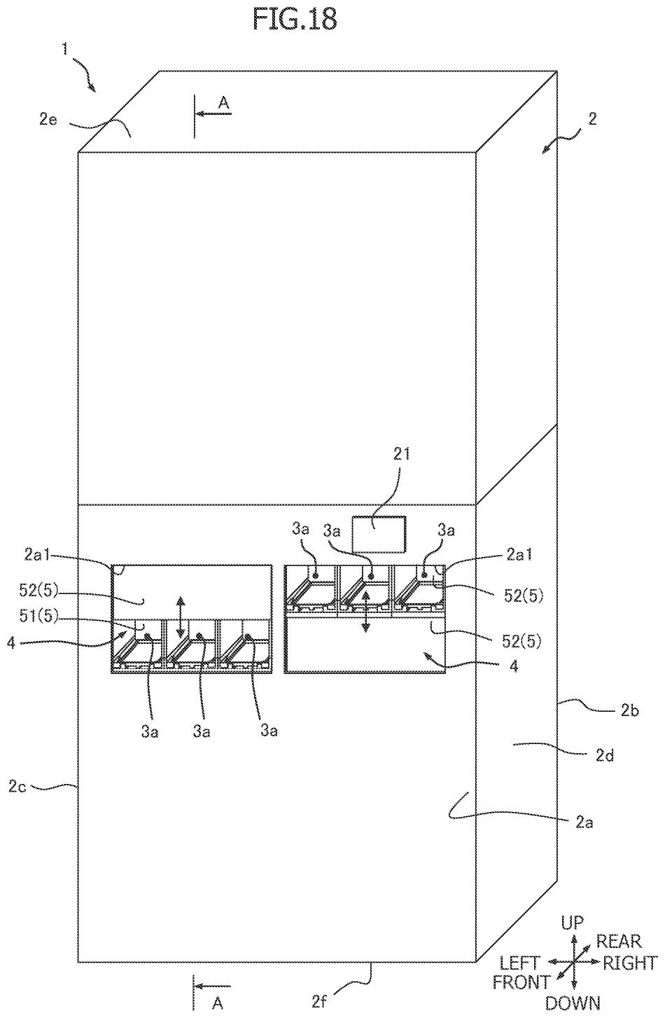

Although FIG. 16 shows one first lifting unit 6, multiple lifting units may be provided as shown in FIG. 17. FIG. 17 is a front view illustrating a modification of the lifting device 8 of the second embodiment. That is, in this modification, multiple first lifting units 6 (two first lifting units in FIG. 17) are provided at intervals in a direction perpendicular to the lifting direction (that is, the left-right direction) in the region below the second lifting unit 7. In this embodiment, the lifting device 8 is configured, for example, so that the width in the left-right direction of the first lifting unit 6 is narrower than that of the first lifting unit 6 shown in FIG. 16, and the first lifting units 6 are arranged within a region between the pair of the vertical frames 732, 732. Thus, the efficiency of transporting articles P is further improved. In this embodiment (the lifting device 8 shown in FIG. 17), as shown in FIG. 18, the door system 5 is provided for each first lifting unit 6 and is configured so that the first door member 51 and the second door member 52 vertically move (that is, the first and second door members are configured to open in the vertical direction). Furthermore, although not shown in the drawings, for example, when the width of the storage 1 (storage shelf 3) can be increased, the lifting device 8 may be configured so that the width in the left-right direction of the second lifting unit 7 is increased, and the multiple first lifting units 6 with the same width as the first lifting units 6 of FIG. 16 are arranged within a region between the pair of the vertical frames 732, 732.

In the first embodiment, the lifting device 8 is a set device including the first lifting unit 6 and second lifting unit 7. However, the present invention is not limited to this lifting device 8. The lifting device 8 may be configured as a device in which the set device is arranged in the left-right direction. In this case, as in the modification of the second embodiment (FIG. 18), the door system 5 is provided for each first lifting unit 6 and the first door member 51 and the second door member 52 vertically move.

In each embodiment, the pantograph arm units 63A of the first lifting system 63 are vertically provided in two steps; however, it is not limited to this, and may be provided in one step or in three or more steps. Furthermore, the arm driving section 63B of the first lifting system 63 is a hydraulic cylinder; however, it is not limited to this, and the arm driving section 63B may be configured as an electric driving section. As the arm driving section 63B, for example, an electric screw cylinder unit can be used. Specifically, although not shown in the drawings, the electric screw cylinder unit includes: a motor for driving an arm; a ball screw that is rotatably driven by the motor; a ball screw support portion that has an end portion rotatably connected to the base 61 (securing side support piece 613) and rotatably supports one end of the ball screw; and a nut portion that has one end portion with a female screw to be screwed to the other end portion of the ball screw and the other end portion rotatably connected to the drive connecting shaft 639 of the pantograph arm unit 63A, and that moves relative to the ball screw support portion when the ball screw rotates. Here, the ball screw support portion corresponds to the fixed portion 63B1, and the nut portion corresponds to the movable portion 63B2.

Furthermore, in each embodiment, it is assumed that the storage 1 is disposed at a factory and used as a storage for inventory management of electronic components required for the products to be manufactured, but it is not limited to the above. The storage 1 may be used, for example, as a vending machine. In this case, the front panel 2a of the storage 1 is provided with, for example, a money slot (a bill slot and a coin slot) and a return slot for money. Furthermore, the touch-screen display 21 displays a screen for selecting articles to be purchased so as to perform a touch operation by a user, and when the user appropriately inserts money, the article P (that is, the selected product) is carried out in response to the touch operation to one of the article placement chamber 3a of the operating station 4.

Although some embodiments of the present invention are described above, the present invention is not limited to the above-described embodiments, and various kinds of modifications and changes can be made based on the technical concept of the present invention.

### REFERENCE SYMBOL LIST

6 First lifting unit
61 Base
62 First lifting platform
63 First lifting system
7 Second lifting unit
72 Second lifting platform
73 Second lifting system
732, 732 Pair of vertical frames
8 Lifting device
P Article

1. A lifting device for raising and lowering an article, comprising:
a first lifting unit including a base, a first lifting platform disposed above the base, and a first lifting system which is provided between the base and the first lifting platform and which raises and lowers the first lifting platform, and
a second lifting unit disposed above the first lifting unit, including a second lifting platform disposed above the first lifting platform, and a second lifting system which raises and lowers the second lifting platform.

2. The lifting device according to claim 1, wherein the first lifting system is a pantograph type lifting system.

3. The lifting device according to claim 2, wherein the second lifting system includes a pair of vertical frames which faces apart from each other in a direction orthogonal to a lifting direction of the second lifting platform, and the second lifting system raises and lowers the second lifting platform between and along the pair of vertical frames.

4. The lifting device according to claim 3, wherein the first lifting unit is arranged in an inner region of the pair of the vertical frames in a plan view in which the second lifting unit is viewed from above.

5. The lifting device according to claim 2, wherein the first lifting system of the first lifting unit has a lifting stroke capable of reaching at least a lower limit region of a lifting range of the second lifting platform which is raised and lowered by the second lifting system, when the first lifting system is maximally extended.

6. The lifting device according to claim 1, wherein the first lifting units are provided at multiple locations spaced apart in a direction orthogonal to the lifting direction in a lower region of the second lifting unit.

7. The lifting device according to claim 1, wherein the second lifting unit is mounted on the first lifting platform of the first lifting unit.
